(19) United States
(12) Patent Application Publication
(10) Pub. No.: US 2013/0091287 A1
(43) Pub. Date: Apr. 11, 2013

(54) SYSTEM FOR CONTACT SUBSCRIPTION INVITATIONS IN A CROSS-DOMAIN CONVERGED ADDRESS BOOK SYSTEM

(71) Applicant: Suresh Chitturi, Plano, TX (US)

(72) Inventor: Suresh Chitturi, Plano, TX (US)

(21) Appl. No.: 13/253,577

(22) Filed: Oct. 5, 2011

(51) Int. Cl. G06F 15/16

(52) U.S. Cl. 709/227

(57) ABSTRACT

A system and method provides subscription invitations for an address book service. The system receives contact subscription invitation requests from originating clients. Contact data from the contact subscription invitation request is extracted. A session initiation protocol (SIP) message based on the extracted contact data is generated. The SIP message includes a user resource identifier (URI) to some or all of the originating client's Personal Contact Card (PCC). A SIP message is then transmitted to remote address book server.

### BACKGROUND

1. Technical Field

The present disclosure relates to an address book service.

2. Related Art

In a social context or other setting, an address book facilitates social relationships between users. An address book may include a list of contact information including a name, physical address, email address, telephone number, personal identification number, image information, website address, and instant messaging information, among others, that enable one user to contact another user. An address book service may also include personal and professional contact information.

Growing innovation across network domains has created many challenges in organizing and managing address book contact information. With diverse address books on many mobile devices, many different types of data formats, and protocols are now in use. While the technology offers many choices for end users, its lack of a unified approach has diminished user experiences.

### BRIEF DESCRIPTION OF THE DRAWINGS

The system may be better understood with reference to the following drawings and description. Moreover, in the figures, like referenced numerals designate corresponding parts throughout the different views.

FIG. 1 is a flow diagram illustrating an example system and method that enables clients to subscribe to other client's PCC (Personal Contact Card) entries through an invitation mechanism.

FIG. 2 is an example data structure containing information that constitutes a contact subscription invitation request.

FIG. 3 is an example Feature Handler XML document that includes information constituting a contact subscription invitation request.

FIG. 4 is an example HTTP POST request.

FIG. 5 is an example of a portion of a cross-domain message.

FIG. 6 is a second example of a portion of a cross-domain message.

FIG. 7, which constitutes FIGS. 7A and 7B, is an example of an address book XML document.

FIG. 8 is a block diagram illustrating an example system architecture.

### DETAILED DESCRIPTION

The present method and system allows clients to subscribe to other client's contact information. Through a global address book standard, such as a Converged Address Book or CAB, an originating client may invite other clients to access some or all of the contact information contained within an originating client's Personal Contact Card (PCC). Some the entries in a PCC may include personal and/or professional information that may include a first name, a last name, a company name, an address, telephone number, e-mail address, fax number, mobile phone number, Web site address, graphics, etc. Each or some of these entries may be associated with a Uniform Resource Identifier or URI that allows receiving clients to identify some (e.g., a contact view) or all of an originating client's PCC entries. The URI may identify the PCC resource on a network by type and location. The entries may be packaged in multiple ways to facilitate social networking across similar or dissimilar network domains.

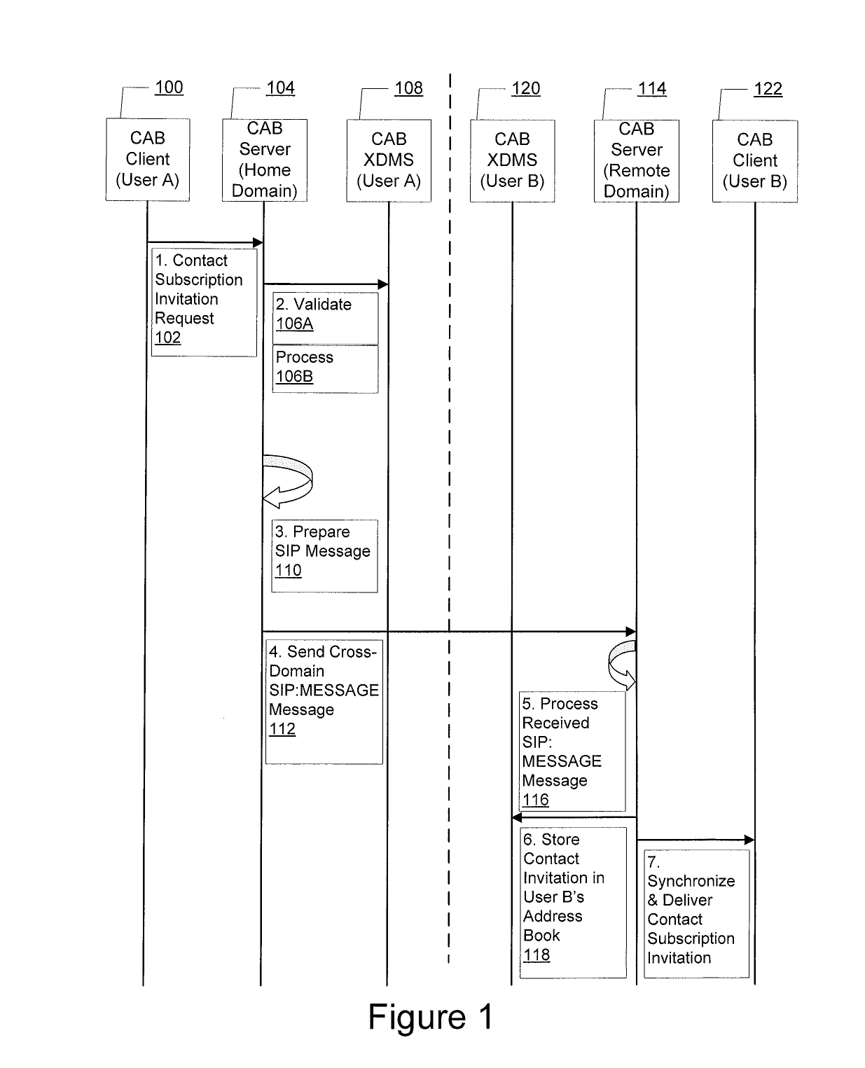

FIG. 1 is a flow diagram illustrating an example system and method that enables clients to subscribe to other client's PCC entries through an invitation mechanism. The flow initiates with an originating client (i.e., an invitee) offering access to some or all of the client's PCC entries in a Converged Address Book (CAB). As shown, an originating CAB client 100 transmits a contact subscription invitation request 102 to a home domain CAB Server 104. In some systems, the contact subscription invitation request 102 may be transmitted from the originating CAB client 100 to the home domain CAB Server 104 through a direct interface. In other systems, the contact subscription invitation request 102 is transmitted from the originating CAB client 100 to the home domain CAB Server 104 through a proxy and an indirect interface. The contact subscription invitation request 102, whether transmitted directly or indirectly to the home domain CAB Server 104, will include subscription invitation information that may be processed by the home domain CAB Server 104, and which may be combined with other information about the originating client. Upon receipt of the contact subscription invitation request 102, the home domain CAB Server 104 may validate 106A the invitation request 102, may process 106B the invitation request 102, or in some instances may both validate 106A and process 106 the invitation request 102.

Validation 106A of the invitation request may include detecting whether an identified recipient of a subscription invitation is also a CAB user. Other validation 106A may be customized to a CAB system provider or the hardware or software that may implement the CAB system.

Processing 106B of the contact subscription invitation request 102 may include extracting data from the invitation request 102. The extracted data may include an information fragment from the originating CAB client 100 or URI associated to some or all of the entries that comprise the originating CAB client's PCC. The URI may be a string of characters that identifies the originating CAB client's PCC that is retained in a network file or network memory that is local or remote to the CAB system. In some systems, the URI may be a uniform resource name that collectively identifies the originating CAB client's PCC. Alternatively, the URI may be a uniform resource locator that provides a location to where the originating CAB client's PCC is retained in the system. The URIs may comply with the “Report from the Joint W3C/IETF URI Planning Interest Group: Uniform Resource Identifiers (URIs), URLs, and Uniform Resource Names (URNs): Clarifications and Recommendations” (RFC 3305).

In some systems, the URI to the originating CAB client's PCC may comprise a contact view of the user's Personal Contact Card. The contact view may be a named subset of the originating CAB client's personal contact information that the originating CAB client is making available to the recipient of the subscription invitation. By providing the recipient of the subscription invitation with a specified contact view of the originating CAB client's contact information, the originating CAB client may control which type, and the amount of information from the originating CAB client's PCC, that is provided to the recipient of the subscription invitation. In other systems, the originating CAB client may also specify a filter that may be applied to the specified contact view before the subscription invitation is presented to the recipient (e.g., content filtering). The filter may limit the amount of contact information that is provided to a recipient of the subscription invitation. In some systems, data about an originating CAB client's contact view may be retained in a local or remote repository, such as a CAB XML Document Management Server (XDMS) 108.

The data extracted from the contact subscription invitation request 102 may also indicate if the originating CAB client 100 has granted subscription permission to the recipient. Granting subscription permission in the contact subscription invitation request 102 may eliminate or minimize the transmission of additional notifications or messages by the system after a recipient accepts the subscription invitation, and the recipient wishes to subscribe to the originating client's PCC. When subscription permission is not fully or partially granted in advance by the originating CAB client 100, exchanges between the originating and receiving CAB clients may occur to resolve access or update issues.

In response to receiving the contact subscription invitation request 102, the home domain CAB Server 104 may generate a cross-domain message 110 for wireless or wired transmission 112 to a remote CAB Server 114. The cross-domain message 110 generated by the home domain CAB Server 104 may be conveyed based on a signaling protocol that is used for controlling communication systems between multiple parties over an internet protocol, such as the Session Initiation Protocol (SIP), SIP:MESSAGE message, or another protocol that supports network-to-network interfaces (NNI) for interaction between two trusted domains. The cross-domain message 110 may include signaling and payload definitions that route the cross-domain message 110 to the remote CAB Server 114. Additionally, the cross-domain message 110 may include subscription invitation content.

The transmitted cross-domain message 110 may be processed 116 by a remote CAB Server 114. Processing 116 of the cross-domain message may cause the remote CAB Server 114 to initiate an inquiry into whether the identified recipient has elected to accept subscription invitations. A recipient's preferences to accept subscription invitations may be retained in a network file, data structure or storage that may be retained in a user preference document management server. Where the recipient's preference is to decline to accept subscription invitations, the remote CAB Server 114 may dispose of the received cross-domain message 110. Where the recipient has elected to receive subscription invitations, the remote CAB Server 114 decodes the subscription invitation content that was included in the cross-domain message, and creates a contact card 118 in the recipient's address book that may be stored in a CAB XDMS 120, the created contact card being associated with a portion or an entirety of a PCC associated with a user of the originating CAB client 100. The remote CAB Server 114 may employ a contact status function to cause the created contact card associated with the originating CAB client 100 to be stored in the remote CAB user's address book. In some systems, the recipient's address book may be stored in a file or data structure that is retained by a document management server associated with the recipient, such as CAB XDMS 120.

Through a synchronization process, the created contact card retained in the recipient's address book may be delivered to the recipient's CAB client 122, thus making it accessible and viewable by the recipient. The synchronization process may be executed in accordance with an OMA Data Synchronization operation or procedure, or via protocols such as XCAP, SIP:SUBSCRIBE and SIP:NOTIFY associated with OMA XML Document Management (XDM), or other modes that causes the contact card to be delivered to the remote CAB user.

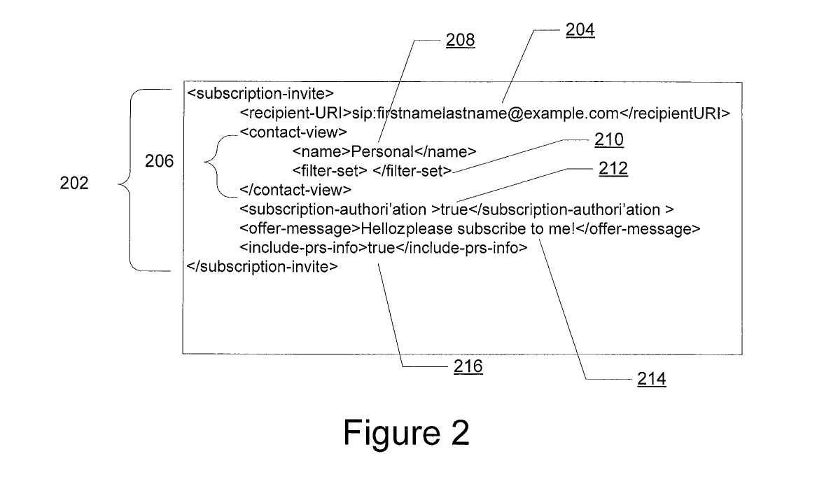

FIG. 2 is an example data structure containing information that constitutes a contact subscription invitation request, which may be similar to request 102 shown in FIG. 1. As shown in FIG. 2, invitation information may be included in a subscription-invite element 202. A recipient URI 204 may identify the recipient to which the contact subscription invitation request is directed.

A contact view element 206 may identify the contact view and filter details, when specified, that determine how the originating CAB client's contact information is presented to a recipient. In FIG. 2, the specified contact view 208 is named “Personal,” and may define contact information of type “personal” about the originating CAB client 100. Other contact views may include work, family, friends, etc. When a contact view is not specified, a default view, or the entirety of the originating CAB client's PCC, may be used. Filter details 210, which may limit portions of the data specified by the contact view 208, may also be included in the subscription invitation request. In some systems, the filter details 210 may include any of those specified in “An Extensible Markup Language (XML)—Based Format for Event Notification Filtering” (RFC 4661).

A subscription authorization parameter 212 may indicate whether to provide authorization to an incoming contact subscription received from the recipient upon acceptance of the subscription invitation. In some systems, the subscription authorization parameter 212 indicates the status of a particular condition, such a true/false or an on/off parameter. When the subscription authorization parameter 212 is set to “true” (or “on”), the recipient is able to subscribe to the originating CAB client's PCC upon acceptance of the subscription invitation. When the subscription authorization parameter 212 is set to “false” (or “off”), a reactive authorization by the originating CAB client 100 may be performed before the subscription to the remote CAB client 122 is allowed. In some systems, the subscription authorization parameter may be set to a default value, such as “false.”

The contents of the contact subscription invitation request 102 may also include an invitation message 214. The invitation message 214 may be a message that is sent from the originating CAB client 100 to the receiving CAB client 122 requesting that the recipient subscribe to the originating CAB client's PCC. The invitation message 214 may be a standard or customized message that is generated by the originating CAB client 100. Some invitation messages 214 are selectable from one or more templates supplied by a home domain CAB Server 104. In some systems, the invitation message 214 may include text, image data, video data, audio data, or a URI to any of such data.

A presence information parameter 216 may indicate whether to disclose presence information about the originating CAB client 100 to the recipient. Depending on its use, presence information parameter 216 may comprise code or embedded data that identifies some condition about the originating CAB client 100. When the presence information parameter 216 is a true/false (or on/off) parameter, a “true” (or “on”) value may indicate the availability or presence status of the originating CAB client 100 to the recipient. When the presence information parameter is set to “false” (or “off”), no presence information may be disclosed to the recipient. In some systems, the presence information parameter 216 may be set to a default condition internally by the CAB Servers. While FIG. 2 describes a contact subscription invitation request to a single recipient, the same contact subscription invitation request may be sent to two or more receiving CAB clients in a single communication or through multiple communications that may or may not be customized to the recipients.

Transmission of the contact subscription invitation request 102 from the originating CAB client 100 to the home domain CAB Server 104 may occur through a direct or indirect interface. When the transmission is through an indirect interface, another feature or application in communication with the originating CAB client 100 may serve as a proxy to deliver the contact subscription invitation request 102 to the home domain CAB Server 104. In some systems, the Feature Handler Application Usage, as defined in OMA CAB 1.0 may serve as the proxy. In addition to Contact Share requests and Import non-CAB requests that may be handled by the feature handler, the feature handler may also include the contact subscription invitation request 102.

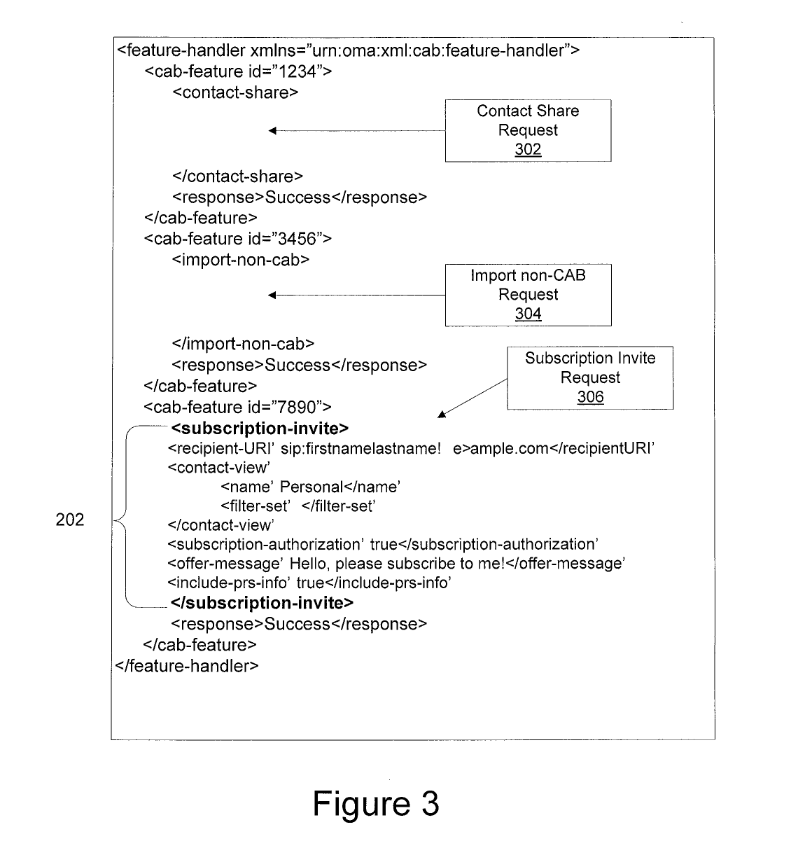

FIG. 3 is an example of a Feature Handler XML document that includes information constituting a contact subscription invitation request, which may be similar to request 102 shown in FIG. 1. As shown in FIG. 3, the Feature Handler XML document identifies how a Contact Share request 302 or an Import non-CAB request 304 may be incorporated into the Feature Handler XML document. In addition to one or both of these requests, a contact subscription invitation request 306 may be included in the Feature Handler XML document. For example, the contact subscription invitation request of FIG. 2 could be inserted into the Feature Handler XML document if the request is to be transmitted in an indirect manner.

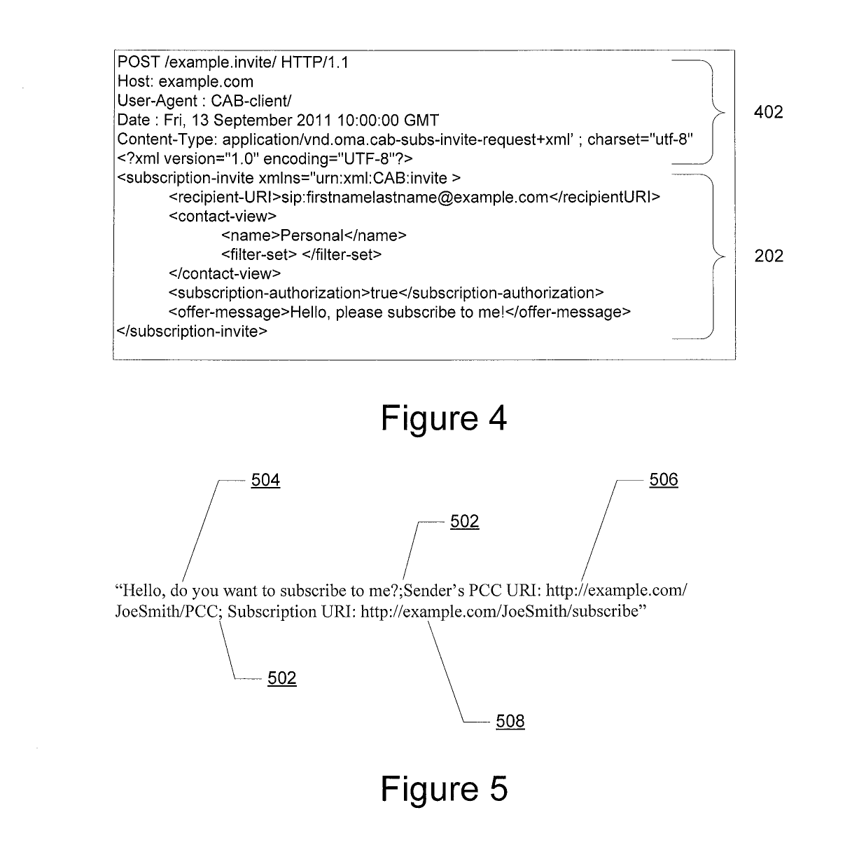

Alternatively, the contact subscription invitation request 102 may be transmitted between the originating CAB client 100 and the home domain CAB Server 104 over a direct interface. FIG. 4 is an example of a HTTP POST request from the originating CAB client 100 to the home domain CAB Server 104. As shown in FIG. 4, the HTTP POST request may include HTTP POST specific header information 402 that may be used to route the request to the home domain CAB Server 104. Information constituting a contact subscription invitation request 202, which may be similar to request 102 of FIG. 1, may be incorporated into the HTTP POST request. For example, the contact subscription invitation request of FIG. 2 is shown incorporated into the HTTP POST request of FIG. 4.

Upon receipt of the contact subscription invitation request 102 from the originating CAB client 100, the home domain CAB Server 104 may validate the request, process the request, or both validate and process the request. When validating the request, the home domain CAB Server 104 may check the recipient URI to determine if the recipient is a CAB user. When the recipient is not a CAB user, the contact subscription invitation request 102 may be denied or discarded. In some systems, the s home domain CAB Server 104 may determine if the recipient is a CAB user through a trial and error authentication process. In these systems, the home domain CAB Server 104 may attempt to transmit one or more test messages to a recipient. If the recipient does not respond to one or more of the test messages, then the home domain CAB Server 104 may determine that the recipient is not a CAB user. In other systems, the home domain CAB Server 104 may have access to a presence server. In these systems, the home domain CAB Server 104 may query the presence server to determine if the presence server has retained data reflecting whether the recipient is a CAB user. In yet other systems, it may be possible for the home domain CAB Server 104 to query the remote domain CAB Server 114 to request information about the recipient. In these systems, the two CAB Servers may exchange lists of CAB users through which the home domain CAB Server 104 may determine if the recipient is a CAB user.

When it is determined that the recipient is a CAB user, the home domain CAB Server 104 may process the contact invitation subscription request 102. Processing of the contact subscription invitation request 102 may include determining the contact view to be transmitted to the recipient, applying any contact filters specified by the originating CAB client 100 or the home domain CAB Server 104, determining whether the originating CAB client 100 has granted the recipient access permission to some or all of its PCC entries for a possible incoming subscription request from the recipient towards the originating CAB client, determining whether the originating CAB client 100 specified an invitation message, or determining whether the originating CAB client 100 has indicated whether presence information is to be provided to the recipient. Where presence information is to be provided, the home domain CAB Server 104 may retrieve the presence information from a presence enabler or process.

After processing the contact subscription invitation request 102, the home domain CAB Server 104 may generate a cross-domain message for transmission to a remote domain CAB Server 114. In some systems, the remote domain CAB Server 114 may be part of a domain that is different or remote from the domain of the home domain CAB Server 104. In some systems, the cross-domain message may be a SIP:MESSAGE message that complies with the “Session Initiation Protocol (SIP) Extension for Instant Messaging” standard, also known as RFC 3428. The message generated by the home domain CAB Server 104 may include header information and body information.

Portions of the header information may include data that was previously extracted from the contact subscription invitation request 102. For example, in some systems, the header information may include various fields to route the cross-domain message to the remote domain CAB Server 114. In some systems, the header information may include a recipient URI field that is populated with the recipient's URI field. The header may also include a “To” field that may likewise be populated with the recipient's URI, and a “From” field which may be populated with the originating CAB client's URL In other systems, the header may include a “display-name” parameter that may be set to the display name of the originating CAB client's PCC.

The body information of the cross-domain message may include the invitation message (e.g., the same, or a modified, version of the invitation message 214 that was included in the contact subscription invitation request 102), a URI to the originating CAB client's PCC (or an embedded contact information fragment), and a subscription URI that the recipient user may directly execute to perform the contact subscription. The body information may be packaged in various forms. In some systems, the information about the originating CAB client 100, recipient, or both may be included in the body information instead of in the message's header.

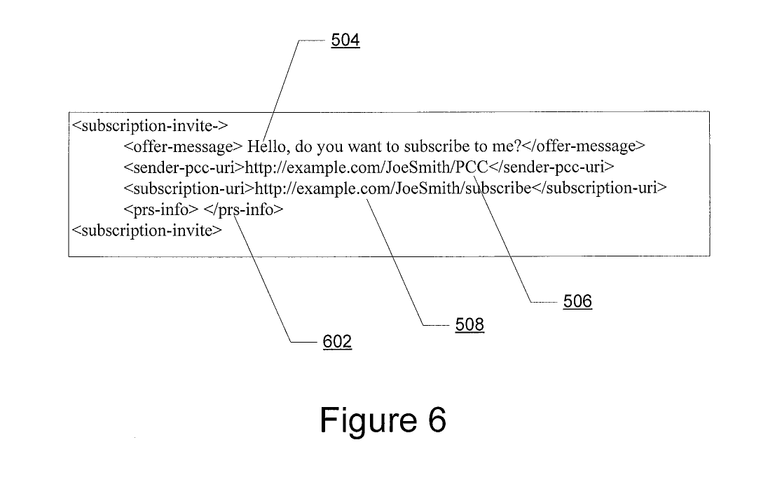

FIG. 5 is an example of body information that may be included as part of the cross-domain message. As shown in FIG. 5, the body information is formatted into a text message with the content of the information separated by a special character 502, such as a semi-colon; however other characters may be used. The invitation message 504 may be a custom or template message, and may extend an invitation for the recipient to subscribe the inviting user's PCC. The inviting user's PCC URI 506 may provide a direct link for the remote domain CAB Server 114 to locate the inviting user's contact view or PCC information. The subscription URI 508 may provide a link that when executed by the recipient user executes the contact subscription.

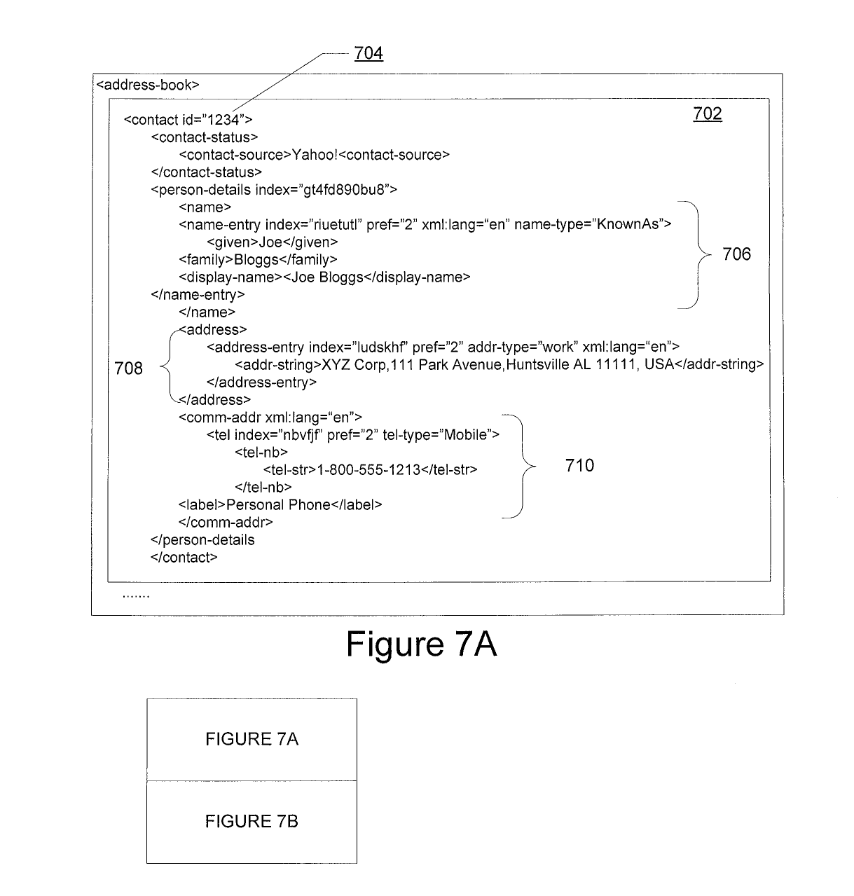

FIG. 6 is a second example of body information that may be included as part of the cross-domain message. The code shown in FIG. 6 could be part of a Multipurpose Internet Mail Extension (i.e., MIME) type that would be directed to transporting subscription invitation messages across multiple domains. This MIME type may for example be identified by an Internet media type header that provides the remote domain CAB Server 114 with the necessary information to process the body information, such as “Content-Type: application/vnd.oma.cab-subs-invite+xml”. As shown in FIG. 6, in addition to the invitation message 504, the inviting user's PCC URI 506, and the subscription URI 508, the body information included in this format may also include presence information 602.

Upon receipt of the cross-domain message, the remote domain CAB Server 114 may evaluate header or body information included in the message to determine the recipient that is to receive the subscription invitation. Once the remote domain CAB Server 114 identifies the recipient, the remote domain CAB Server 114 may determine if the recipient has specified a preference to receive subscription invitations. In some systems, the recipient's preference may be retained in a network file or network memory that is accessible by the remote domain CAB Server 114. The preference may be a designated by a Boolean value (e.g., true/false or on/off). When the preference returns a true value, it may imply that the recipient user would like to receive subscription messages; however counter-logic may be implemented depending on the implementation. In some systems, a user's subscription message preference may be set to a default condition when not specified.

When the recipient is open to receiving subscription invitations, the remote domain CAB Server 114 may generate a contact card entry associated with the originating CAB client 100 in the recipient's address book. In some systems, the remote domain CAB Server 114 may employ a CAB Contact Status function to create this contact card entry.

In some systems, the created contact card entry may include an element to denote that this entry is the result of a subscription invitation. Where the recipient's address book already includes an address book entry for the originating CAB client 100, the created contact entry may further include a reference to this existing address book entry. Additionally, the created contact record may include the invite message sent by the originating CAB client 100, as well as any authorized and available presence information.

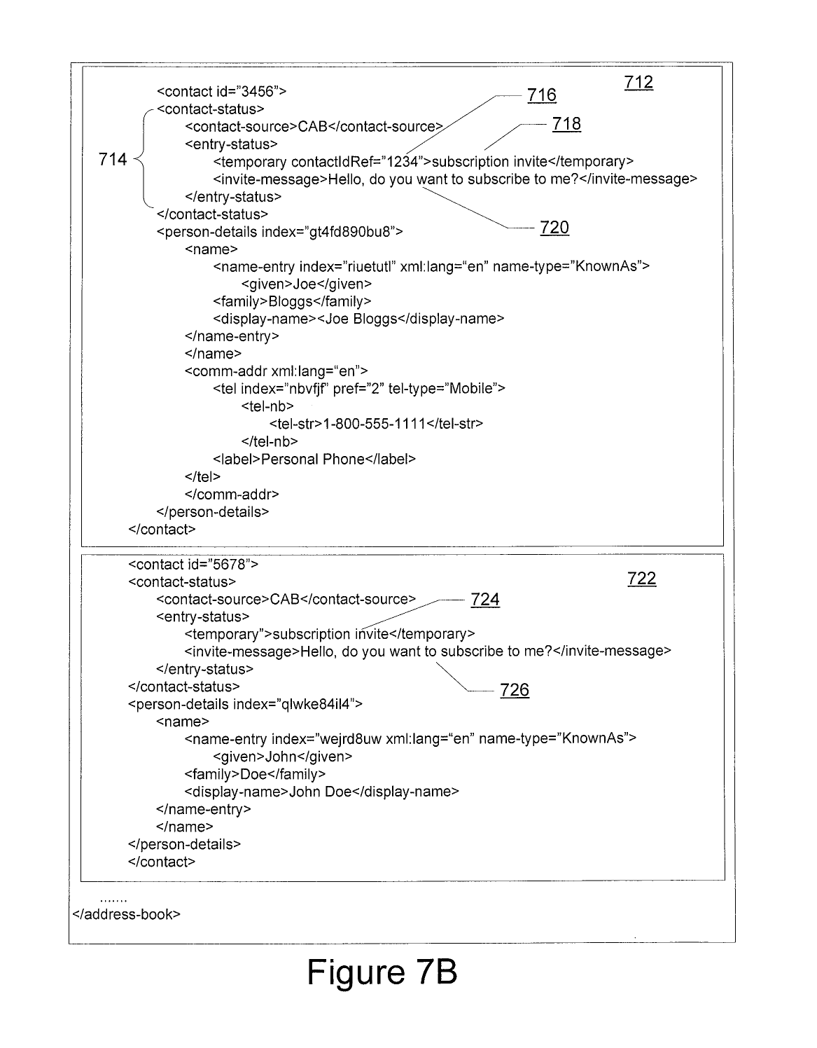

FIG. 7, which constitutes FIGS. 7A and 7B, is an example of a recipient's Address Book XML document. A key illustrating the relationship between FIGS. 7A and 7B is shown below FIG. 7A. In FIG. 7A, a first contact entry 702 is a normal entry that exists in the recipient's address book. A unique contact reference attribute 704 (i.e., <contact id =“1234”> for this entry) may be associated with each contact entry in the recipient's address book. A “name” element 706 indicates that the individual associated with this contact entry is named “Joe Bloggs.” An “address” element 708 and a “comm-addr” element 710 (e.g., a communication address) identify an address and personal phone number, respectively, for Joe Bloggs.

A second contact entry 712, shown in FIG. 7B, is a temporary contact card entry that was created by the remote domain CAB Server 114 and shows a contact card indicating a subscription invitation message that is associated with the existing contact entry of Joe Bloggs. In FIG. 7B, the “contact-status” element 714 illustrates that this contact card is associated with Joe Bloggs' existing contact entry by associating the “contactIdRef' attribute 716 with Joe Bloggs” unique <contact id> (i.e., <contact id=“1234”>). The second contact entry 712 further employs a “subscription invite” attribute 718 to indicate that this contact card is associated with a subscription message. The invite message attribute 720 identifies the invite message that was transmitted by the originating CAB client 100. The name element, address element, and comm-addr element of the second contract entry 712 are identical to those of the first contact entry 702. Had the originating CAB client 100 identified a different contact view, or filtered its PCC, some of this information could vary between the first contact entry 702 and the second contact entry 712.

A third contact entry 722, shown in FIG. 7B, is a contact card record that was created by the remote domain CAB Server 114 and shows a contact card indicating a subscription invitation message with no association to any existing contact entry. In the third contract entry 722, the contactIdRef attribute is not used; this may imply that this entry is not associated with other entries in the recipient's address book. The third contact entry 722 does include a “subscription invite” attribute 724 indicating that this address book entry was the result of a subscription invite. A separate invite message 726 is included with this contact entry.

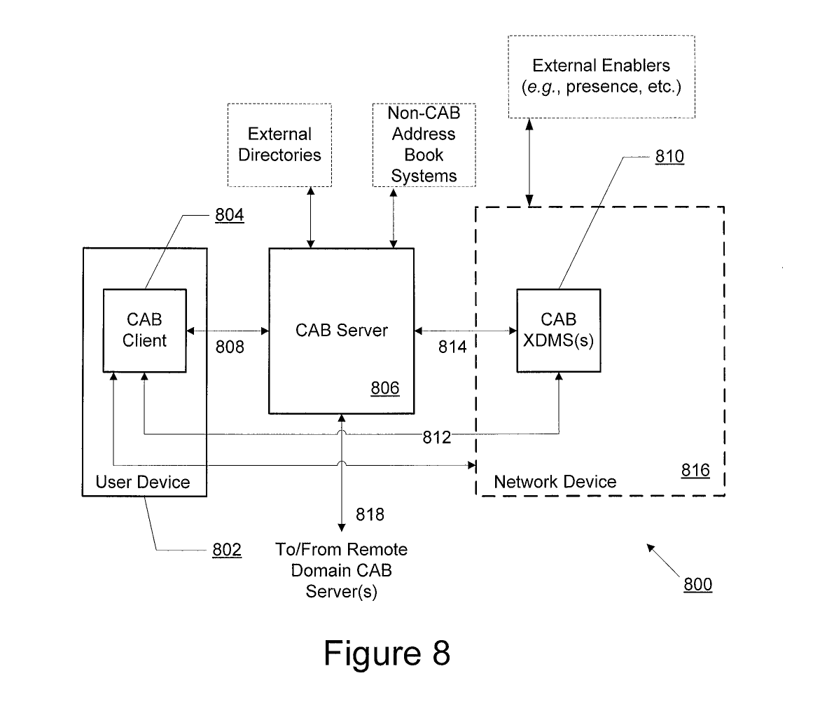

FIG. 8 is a block diagram illustrating a system architecture 800. The system architecture 800 may support a converged address book service with respect to the previously-described subscription invitation operations and methods. A user device 802 may use a converged address book that may include or otherwise employ a CAB client 804. The user device 802 may be configured as a mobile telephone, smartphone, personal digital assistant, two-way pager, tablet, tablet computer, personal computer, laptop computer, set-top boxes, or other network entity acting on behalf of a user. The user device 802 may include an input interface and an output interface that allows a user to interact with the converged address book via CAB client 804. A user may input information into the user device 802 through a keyboard, keypad or cursor control device such as a mouse, joystick, touch screen display, or any other device that allows a user to interact with the converged address book via CAB client 804. Information may be output or otherwise presented to the user through a display, tactile or aural device that is in communication with the user device 802.

The CAB client 804 may be invoked, instantiated or otherwise executed by a processor operating on the user device 802. The processor may execute computer or machine-readable instructions (which constitute the CAB client) stored on non-transitory medium retained in a local or network file or memory that permit interaction with a user as well as with a CAB Server. The syntax or protocol that may be used to permit communications between the CAB client 804 and a CAB Server may depend upon the programming language or interface specification used with the CAB system, but may include Internet Protocol (IP) protocols such as HTTP, SIP, XCAP, SOAP, XML-RPC, or other protocols that provide the necessary syntax to convey information between the elements of the CAB architecture.

A CAB Server 806 may be invoked, instantiated or otherwise executed by a network device (not shown), such as a server computer that includes a processor, a memory, software retained in a non-transitory media, and an interface(s). The processor may execute computer or machine-readable instructions (which constitute the CAB Server) stored on a non-transitory medium retained in a local or network file or memory.

The processor of the network computing device that executes the CAB Server 806 may be a central processing unit (CPU) or other slave processing unit. The CAB Server processor may be coupled, integrated or unitary with the memory, or the memory may be a separate component. The computer-readable or machine-readable instructions constituting the CAB Server may be retained in the memory. In some embodiments, the memory may include, but is not limited to, computer readable storage media such as volatile or non-volatile storage media, including random access memory, read-only memory, programmable read-only memory, electrically programmable read-only memory, electrically erasable read-only memory, flash memory, magnetic tape or disk, optical media, or the like.

The processor executing the CAB Server may process requests received from a CAB client such as the requests described with reference to FIGS. 2-4 and 7, or may process requests received from another CAB Server or component of a document management enabler, such as a CAB XDMS. Additionally, the processor executing the CAB Server may generate messages for transmission to document management enabler components or other CAB Servers, such as the cross-domain messages, described with reference to FIGS. 5-6, and process similarly received messages. These transmitted or received messages may be communicated via a communication path such as 818.

The CAB Server 806 may provide functionality that may include User Account Manager and Authentication Agent, a Notification Function, CAB XML Document Management Client (XDMC), Contact Search Function, Contact Subscription Function, Contact Share Function, Contact Status Function, and Interworking Function. The User Account Manager and Authentication Agent may be responsible for managing user authentication and account information including user preferences and custom aspects, such as configuration to synchronize only partial address book data from the server to the client, and to receive or not receive notifications, among others.

The Notification function may notify clients of updates to the address book, such as updates to the subscribed contacts, and other notifications pertaining to the contacts in the address book. The function may use an OMA Data Synchronization framework or other mechanisms, such as email, SMS, Instant Messaging, or SIP Notify, among others.

The CAB XDMC may be responsible for the access and manipulation of address book data such as a PCC and address book information retained in a CAB XDMS or separate address book storage. The Contact Search function may be responsible to search for contact information with the CAB system, within a remote CAB system, or in an external database made available by a CAB service provider.

The Contact Subscription function allows a user to receive automatic updates of another CAB user's available PCC. The Contact Share functionality may allow a CAB user to share his or her contact information with other users. The Contact Status functionality may allow a CAB user to retain notification and status information about another user in an address book.

The CAB Server 806 may communicate with the CAB client 804 through a direct interface 808. Alternatively, the CAB Server 806 may communicate with the CAB client 804 through a proxy model. In one embodiment, the proxy model may include an interface 812 between the CAB client 804 and a CAB XDMS 810, and an interface 814 between the CAB XDMS 810 and the CAB Server 806.

The CAB XDMS 810 may be invoked, instantiated or otherwise executed by a processor operating on a network device 816. The processor may execute computer or machine-readable instructions (which constitute the CAB XDMS) stored on non-transitory medium retained in a local or network file or memory. In some embodiments, a common network device may invoke the CAB Server 806 and the CAB XDMS 810.

The CAB XDMS 810 may operate under a XDM Enabler architecture and may include proxy elements and SIP/IP core and cross-network proxies to support network-to-network interfaces for interaction between two trusted domains (e.g., a home or visited network domain which have a trust relationship between each other). In some embodiments, the CAB XDMS 810 may constitute multiple servers that may include any or all of a CAB Address Book XDMS, a CAB PCC XDMS, a CAB User Preference XDMS, and a CAB Feature Handler XDMS.

While FIG. 8 illustrates communication paths 808, 812, 814, and communication paths to external directories, non-CAB address book systems, external enablers, and communication path 818 to/from remote domain CAB server(s) as single paths, it is to be understood that any of these communication paths may constitute one or more directional or bi-directional communication paths. In some embodiments, any of these communication paths may be configured to carry protocol specific communications. In other embodiments, multiple different protocols communications may be carried over a similar communication path. It is to be further understood that while FIGS. 2-7 illustrate example documents or requests in XML or SIP formats, these examples are not intended to limit the scope of the present disclosure. Any of the referenced documents or requests may be mapped to other network or communication protocols, including without limitation, a HTTP protocol, a RESTful implementation of HTTP protocol, an Instant Message (IM) protocol, a Short Message Service (SMS) protocol, a Multimedia Message Service (MMS) protocol, an email protocol, or other data transport protocol.

While various embodiments of the disclosure have been described, other embodiments and implementations are possible. Accordingly, the disclosure is not to be restricted except in light of the attached claims and their equivalents.

I claim:

1. A method performed by a converged address book (CAB) server, the method comprising:
receiving a contact subscription invitation request from an originating converged address book (CAB) client;
extracting data from the contact subscription invitation request;
generating a session initiation protocol (SIP) message based on the data which was extracted, the SIP message containing a uniform resource identifier (URI) associated with a personal contact card (PCC) that represents a user of the originating CAB client; and
transmitting the SIP message to another converged address book server.

2. The method of claim 1, further comprising identifying the URI associated with the originating CAB client.

3. The method of claim 1, wherein the data which was extracted comprises a URI associated with a remote CAB client.

4. The method of claim 3, further comprising evaluating the contact subscription invitation request to determine if the remote CAB client is authorized to receive the contact subscription invitation request from the originating CAB client.

5. The method of claim 1, wherein the URI identifies a contact view that limits access to a portion of the PCC.

6. The method of claim 1, wherein transmitting comprises sending the SIP message from one domain to another domain.

7. A network device comprising:
a processor executing an address book server configured to perform the operations of:
receiving a contact subscription invitation request from an originating converged address book (CAB) client;
extracting data from the contact subscription invitation request;
generating a session initiation protocol (SIP) message based on the data which was extracted, the SIP message containing a uniform resource identifier (URI) associated with a personal contact card (PCC) that represents a user of the originating CAB client; and
transmitting the SIP message to another converged address book server.

8. The network device of claim 7, wherein the processor is further configured to identify the URI associated with the originating CAB client.

9. The network device of claim 7, wherein the data which was extracted comprises a URI associated with a remote CAB client.

10. The network device of claim 9, wherein the processor is further configured to evaluate the contact subscription invitation request to determine if the remote CAB client is authorized to receive the contact subscription invitation request from the originating CAB client.

11. The network device of claim 7, wherein the URI identifies a contact view that limits access to a portion of the PCC.

12. The network device of claim 7, wherein the processor if further configured to send the SIP message from one domain to another domain.

13. A method performed by a converged address book (CAB) server, the method comprising:
receiving a subscription invite message from another converged address book (CAB) server;
extracting recipient data from the subscription invite message;
extracting from the subscription invite message invitation data associated with an originating CAB client; and
generating an address book entry in a remote CAB client's address book based on the extracted invitation data associated with the originating CAB client.

14. The method of claim 13, further comprising extracting contact information about the originating CAB client from the invitation data.

15. The method of claim 13, wherein the extracted invitation data includes an invitation message from the originating CAB client.

16. The method of claim 13, wherein the extracted invitation data includes a subscription uniform resource identifier (URI) that performs a contact subscription when executed.

17. The method of claim 13, wherein the generated address book entry is associated with another pre-existing entry in the remote CAB client's address book.

18. The method of claim 13, wherein the subscription invite message, which is received, originates from a remote domain that is different from a domain in which the CAB server is configured.

19. A network device comprising:
a processor executing an address book server configured to perform the operations of:
receiving a subscription invite message from a another converged address book (CAB) server;
extracting recipient data from the subscription invite message;
extracting from the subscription invite message invitation data associated with an originating CAB client; and
generating an address book entry in a remote CAB client's address book based on the extracted invitation data associated with the originating CAB client.

20. The network device of claim 19, wherein the processor is further configured to extract contact information about the originating CAB client from the invitation data.

21. The network device of claim 19, wherein the invitation data includes an invitation message from the originating CAB client.

22. The network device of claim 19, wherein the extracted invitation data includes a subscription uniform resource identifier (URI) that performs a contact subscription when executed.

23. The network device of claim 19, wherein the generated address book entry is associated with another pre-existing entry in the remote CAB client's address book.

24. The network device of claim 19, wherein the subscription invite message, which is received, originates from a remote domain that is different from a domain in which the CAB server is configured.
